(19) United States
(12) Patent Application Publication
(10) Pub. No.: US 2004/0103981 A1
(43) Pub. Date: Jun. 3, 2004

(54) Method of producing a jointless and porous granular covering, and granular covering produced by this method

(75) Inventor: Heini Zollinger, Ennetbadem (CH)

Correspondence Address: William H. Logsdon, 700 Koppers Building, 436 Seventh Avenue, Pittsburgh, PA, 15219-1818, US

(73) Assignee: WALO BERTSCHINGER AG

(21) Appl. No.: 10/720,646

(22) Filed: Nov. 24, 2003

(30) Foreign Application Priority Data
Nov. 25, 2002 (EP) 02 406 018.8

(51) Int. Cl. E01C 7/00; B31F 1/00

(52) U.S. Cl. 156/209; 156/62.2; 404/17

(57) ABSTRACT

In order to produce a jointless and porous granular covering (1), rubber-elastic granules (3) and a binder (5) are mixed and applied to a base (7) to form a sheetlike surfacing (6). Prior to the curing of the binder (5), the sheetlike surfacing (6) is compacted and smoothed on its upper side (11). Prior to the curing of the binder (5), the compacted surfacing (15) is provided with a texture (20) on its upper side (14) by being subjected to mechanical pressure using an uneven embossing face (19). The granules (3) preferably have a mean particle size in the range from 0.1 to 3 mm, preferably 0.5 to 1.5 mm.

The invention relates to a method of producing a jointless and porous granular covering, in which rubber-elastic granules and a binder are mixed and applied to a base to form a sheetlike surfacing. Granular coverings have proved to be suitable per se as resilient surfacings both for popular sport and top-level sport and have found widespread use. They are required to be all-weather-resistant, wear-resistant and, when used as a running surface, spike-resistant. The advantage of porous granular coverings is that they dry out more quickly than impermeable surfacings which are produced by poured layers or laying vulcanized rubber mats. Such water-impermeable surfacings carry the risk that blisters may form as a result of vapour pressure, making it necessary to replace or repair the surfacing.

A sports surfacing for a running track must be textured on the upper side. At the same time, such a surfacing should be wear-resistant and, in particular, spike-resistant. According to known methods, a resilient layer is formed on a level base composed of granules and binder. For this resilient layer, the granules can be produced from black or coloured granules. A wearing layer is sprayed or poured onto this layer and granules are scattered into the liquid layer. The granules protruding on the upper side form a textured surface. A schematic section through such a granular covering is depicted in FIG. 6. The granules protruding at the surface are still partially bound in and may become loose when the surface is used. In the case of a granular covering with a sprayed wearing layer, there is thus the difficulty that the wear is comparatively high. The surface granules could be consolidated by applying a binder. However, this leads to a comparatively hard surface and reduced water permeability.

The object on which the invention is based is to provide a method of the aforementioned type, by means of which it is possible to produce a granular covering which is more wear-resistant and, in particular, more spike-resistant. Nevertheless, it should be possible to implement the method in a simple and cost-effective manner.

The invention is achieved in that, prior to the curing of the binder, the sheetlike surfacing is compacted and smoothed on its upper side, and in that, prior to the curing of the binder, the compacted surfacing is provided with a texture on its upper side by being subjected to mechanical pressure using an uneven embossing face. The method according to the invention makes it possible to produce a granular covering in which the granules on the upper side are bound in substantially more firmly than in the prior art. The surface texture here is not formed by individual granular particles but by depressions which have been incorporated into the upper side of the granular covering.

A particularly high wear resistance results if, according to a development of the invention, the granules have a particle size in the range from 0.1 to 3 mm, preferably 0.5 to 1.5 mm. The average particle size is substantially smaller here than in the case of the known granular coverings. The granules are particularly firmly embedded on the upper side and cannot become detached from the composite when subjected to loading, for example as a result of the loading applied during track events. It is possible for essentially any desired textures to be produced by selecting different embossing faces. A texture which is of similar design to the outside of a golf ball has been found to be particularly advantageous. However, it is advantageous for the depressions to be arranged irregularly.

According to a development of the invention, provision is made for the compacted surfacing to be textured using a roller. The roller has an uneven roller surface which is designed to be complementary to the texture of the granular covering. Such a roller is preferably pushed by hand. Changing its direction makes it possible to create an irregularly textured surface. It is essential that the surfacing is textured before such time as the binder has cured. In the case of a binder composed of a polyurethane, several hours are available here.

The method according to the invention makes it possible to produce a single-layer or multi-layer granular covering. The method thus also makes it possible to produce a two-layer granular covering, in which the lower layer consists of black or coloured rubber granules based on SBR or EPDM granules and a binder. This layer can have a higher elasticity than the upper wearing layer and serves to improve force reduction.

The invention is explained in more detail below with reference to the drawing, in which:

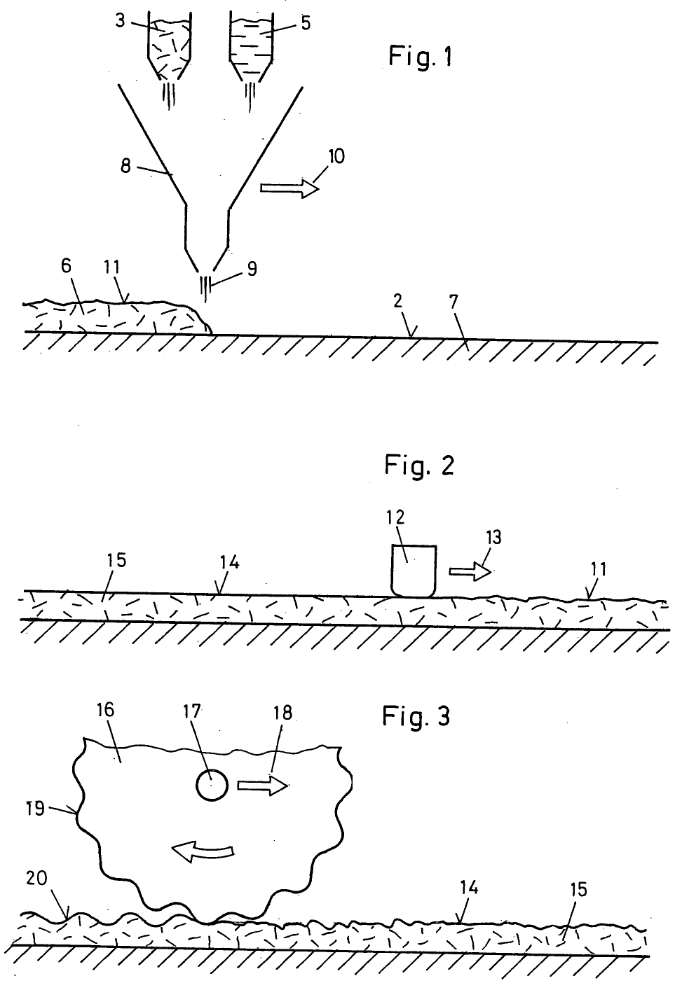

FIG. 1 schematically shows the application of a surfacing to a base;

FIG. 2 schematically shows the smoothing of the surfacing;

FIG. 3 schematically shows the texturing of the smoothed surfacing;

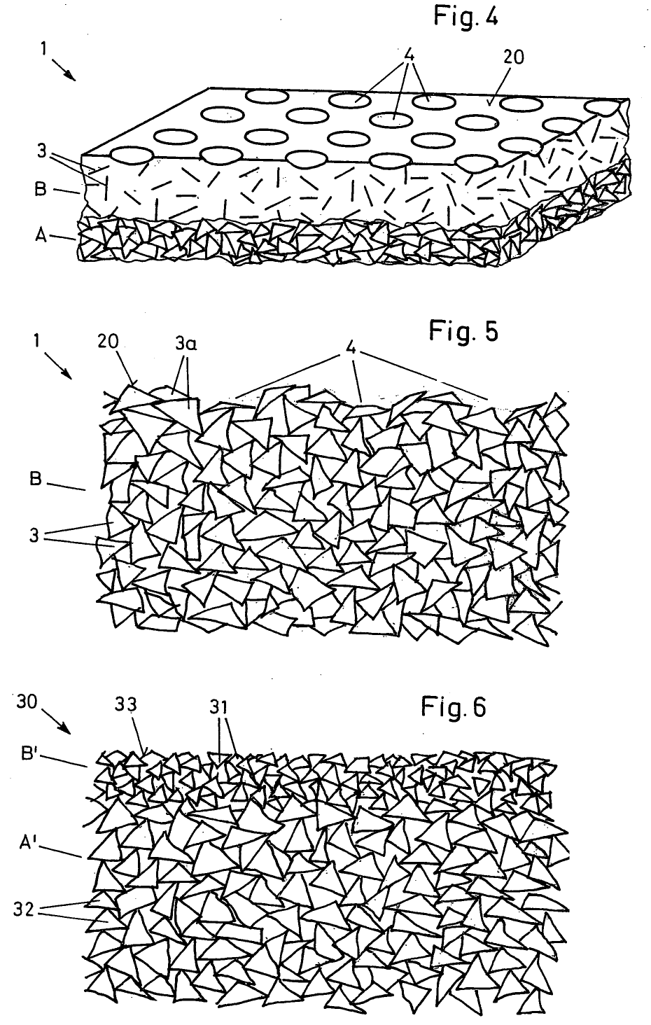

FIG. 4 schematically shows a spatial representation of a detail of a granular covering according to the invention;

FIG. 5 schematically shows, on an enlarged scale, a section through a granular covering according to the invention; and

FIG. 6 schematically shows a section through a granular covering according to the prior art.

To produce a granular covering according to the invention, for example for a sports ground, a level base 7 is produced from asphalt. A surfacing 6 composed of granules 3 and a binder 5 is applied to the level upper side 2 of the base 7 using a hopper 8. The granules 3 and the binder 5 are added to the laying machine in a mixed state or poured by hand and applied as a mix 9.

The granules 3 are, in particular EPDM granules having a mean particle size in the range from 0.1 to 3 mm. The mean particle size is preferably from 0.5 to 1.5 mm. The binder 5 is a polyurethane known per se and has a curing time of several hours. The surfacing 6 is applied in strips which are jointlessly interconnected prior to the curing of the binder 5.

After the surfacing 6 has been applied, it is smoothed on the upper side using a heated screed 12, as shown in FIG. 2. The screed 12 is likewise attached to a vehicle (not shown here) and is moved in the direction of the arrow 13 in FIG. 2. The screed 12 produces a compacted surfacing 15 having a level surface 14. The uneven surface 11 of the surfacing 6 is thus smoothed, and the surfacing 6 is consolidated at the same time. The thickness of the surfacing 15 is identical all over and is, for example, 0.1 to 3 cm.

As shown in FIG. 3, a roller 16 having a textured roller face 19 is pushed over the consolidated surfacing 15. In FIG. 3, the roller 16 rotates in the clockwise direction about an axle 17 and is moved from left to right in the direction of the arrow 18. The smooth upper side 14 of the compacted surfacing 15 is embossed by face 19 and provided with a textured upper side 20. The roller 16 can be passed several times over the compacted surfacing 15 in different directions or with the direction remaining the same. The surface texture then becomes irregular with depressions 4, as shown in FIGS. 4 and 5. The roller 16 is passed over the compacted surfacing 15 before such time as said surfacing 15 has cured. After the application of the surfacing 6 as shown in FIG. 1, a few hours are available for this purpose. The roller 16 may be heated, to prevent granules from adhering firmly to the surface 19. The roller 16 causes the granules on the upper side to be pressed into, and thus embedded in, the surfacing 15. As a result, the wear resistance mentioned is improved. A comparison of FIGS. 5 and 6 shows that the granules are embedded differently on the upper side. The granular covering 30 according to the prior art shown in FIG. 6 has a resilient lower layer A′ and a wearing layer B′. The granules 32 of the resilient layer A′ are produced from rubber granules. The wearing layer B′ consists of sprayed granules 31 which form an upper side 33 on which individual granular particles 31 protrude in a pointed manner. In the granular covering 1 as shown in FIG. 5, the wearing layer b consists of comparatively fine-particle granules 3 and has an upper side 20 which is textured by means of depressions 4. As explained above, the depressions 4 were produced by embossing with the roller 16. The granules 3a on the upper side have been consolidated by means of these rollers and form a very wear-resistant surface.

FIG. 4 shows a detail of the granular covering 1, and it can be seen that the depressions 4 are distributed irregularly or regularly over the upper side 20.

The use of a roller 16 with an even roller face makes it possible to produce a granular covering 1 in such a way that, at least in certain regions, the upper side 20 is smooth. The same granular covering 1 can thus be textured in certain regions and smooth in certain regions. On the same granular covering 1 it is thus possible to produce a textured region for track events and, at the same time, a region having a level surface, for example for ball games. It is also possible to produce regions having different texturing. The granular covering 1 is porous both in terms of layer A and layer B. Water is thus able to flow off downwards from the upper side 20.

1. Method of producing a jointless and porous granular covering (1), in which rubber-elastic granules (3) and a binder (5) are mixed and applied to a base (7) to form a sheetlike surfacing (6), characterized in that, prior to the curing of the binder (5), the sheetlike surfacing (6) is compacted and smoothed on its upper side (11), and in that, prior to the curing of the binder (5), the compacted surfacing (15) is provided with a texture (20) on its upper side (14) by being subjected to mechanical pressure using an uneven embossing face (19).

2. Method according to claim 1, characterized in that the granules (3) have a mean particle size in the range from 0.1 to 3 mm, preferably 0.5 to 1.5 mm.

3. Method according to claim 1 or 2, characterized in that the compacted surfacing (15) is textured using a roller (16) which has an uneven roller surface (19).

4. Method according to one of claims 1 to 3, characterized in that the surfacing (6) is compacted and smoothed using a heated screed (12).

5. Method according to one of claims 1 to 4, characterized in that the compacted and smoothed surfacing (15) is textured using a heated or unheated roller (16).

6. Method according to one of claims 1 to 5, characterized in that the compacted and smoothed surfacing (15) is provided with an irregular texture (20).

7. Granular covering produced by the method according to claim 1, characterized in that its upper side (20) has been provided with elevations and depressions (4) in an irregular or regular arrangement.

8. Granular covering according to claim 7, characterized in that it is intended for sports facilities.

9. Granular covering according to claim 8, characterized in that it forms the surfacing of a running track.

10. Granular covering according to claim 1, characterized in that it is intended for a gymnastics area, play area or school playground and has regions of different texture or with a smooth upper side.
